(19) United States
(12) Patent Application Publication
(10) Pub. No.: US 2017/0301968 A1
(43) Pub. Date: Oct. 19, 2017

(54) THERMAL ISOLATION MATERIAL AND METHODS OF MAKING AND USING THE SAME

(71) Applicant: ADA TECHNOLOGIES, INC., Littleton, CO (US)

(72) Inventors: Daniel Cooney, Golden, CO (US); Stephen Cordova, Colorado Springs, CO (US); Sayangdev Naha, Littleton, CO (US)

(73) Assignee: ADA TECHNOLOGIES, INC., Littleton, CO (US)

(21) Appl. No.: 15/473,260

(22) Filed: Mar. 29, 2017

Related U.S. Application Data
(60) Provisional application No. 62/314,820, filed on Mar. 29, 2016.

(51) Int. Cl. H01M 10/658; H01M 2/16; C09D 5/18; H01M 10/0525; C09D 5/00

(52) U.S. Cl. CPC H01M 10/658; H01M 10/0525; C09D 5/00; C09D 5/185; H01M 2/1686

(57) ABSTRACT

The patent application relates generally to a thermal isolation material, more particularly to a thermal isolation material having at least an intumescent layer and a refractory layer. The intumescent and refractory layers are generally stacked on top of one other. The patent application also generally relates to a method of making the thermal isolation material that includes the steps of providing a substrate having opposing first and second sides, applying an intumescent material to the substrate and applying a refractory material to the substrate to form a thermal isolation material, where the one following can be true: (i) the intumescent material is applied on the first side and wherein the refractory material is applied on the second side; (ii) the intumescent material is positioned between the substrate and the refractory material and (ii) the refractory material is positioned between the substrate and the intumescent material.

### CROSS REFERENCE TO RELATED APPLICATIONS

The present application claims priority under 35 U.S.C. §119 to U.S. Provisional Patent Application No. 62/314,820 with a filing date of Mar. 29, 2016, entitled “Large Format Lithium Ion Batteries and Methods for Making and Using the Same” which is incorporated in its entirety herein by this reference.

### STATEMENT REGARDING FEDERALLY SPONSORED RESEARCH OR DEVELOPMENT

The invention was made with Government support under Contract Nos. FA8650-14-M-2490 and FA8650-15-C-2554, both awarded by the Air Force. The Government has certain rights in the invention.

### FIELD

The following disclosure relates generally to a thermal isolation material, more particularly to a thermal isolation material and methods of making and using the same.

### BACKGROUND

Large-format lithium-ion (Li-ion) batteries possess ineffective cell isolation design, resulting in potentially hazardous events when exposed to conditions such as crush, overcharge, discharge, high temperature, and internal short circuit. In the event of cell failure, propagation of heat can occur, from a defective/damaged cell to the surrounding ones in a battery pack, leading to a domino-effect, resulting in an extensive thermal runaway. The failure modes of the battery packs point to the need for more robust cell isolation and that encompassing cells with insulation material is an insufficient means of preventing cell-to-cell thermal runaway and subsequent deflagration.

### SUMMARY

These and other needs are addressed by the various embodiments and configurations of the present invention. The present invention can provide a number of advantages depending on the particular configuration.

In accordance with some embodiments is a composition having an intumescent material, a refractory material and a substrate positioned between adhered to each of the intumescent material and the refractory material. In some embodiments, each of the intumescent material and the refractory material can be layers. In some embodiments, each of the intumescent material and the refractory material can be one or more of flexible and bendable around a radii of curvature of 10 mm or more diameter. The substrate can be a metallic folio having a thickness of no more than about 1,600 micrometers. The intumescent material layer can have a thickness of no more than about 800 micrometers. The refractory material layer can have a thickness of no more than about 800 micrometers. In some embodiments, the refractory material can include a binder.

In accordance with some embodiments is a composition having a substrate, a refractory material layer and an intumescent material layer. The substrate can be positioned between and adhered to the intumescent material layer and the refractory material layer. Moreover, the substrate, the intumescent material and the refractory material can be one or more of flexible and bendable around a radii of curvature of 10 mm or more diameter. In some embodiments, the substrate can be a metallic folio having a thickness of no more than about 1,600 micrometers. The intumescent material layer can have a thickness of no more than about 800 micrometers. The refractory material layer has a thickness of no more than about 800 micrometers. In some embodiments, the refractory material can include a binder.

In accordance with some embodiments is a method that includes the steps of providing a substrate having opposing first and second sides, applying an intumescent material to the substrate and applying a refractory material to the substrate to form a thermal isolation material. In accordance with some embodiments of the method the one following can be true: (i) the intumescent material is applied on the first side and wherein the refractory material is applied on the second side; (ii) the intumescent material is positioned between the substrate and the refractory material and (ii) the refractory material is positioned between the substrate and the intumescent material. The method can include in some embodiments the step of modifying one or more of the first and second sides. The modification of the one or more first and second sides can include one or more of introducing surface variations and forming surface reactive groups. In some embodiments, the step of applying the intumescent material to the substrate can include contacting the intumescent layer with one of first and second surfaces of the substrate. In some embodiments, the step of applying the refractory material can include contacting the refractory material with the other of first and second surfaces of the substrate. In some embodiments, the step of applying the intumescent material to the substrate can include applying the intumescent material with one or more of a kiss-roller, curtain coater, matte applicator, a draw down bar, a spray coater, a screen coater, a calendar coater, and a pad coater. In some embodiment, the step of applying the refractory material to the substrate can include applying the refractory material with one or more of a kiss-roller, curtain coater, matte applicator, a draw down bar, a spray coater, a screen coater, a calendar coater, and a pad coater. In accordance with some embodiments, the method can include degassing one or more the intumescent material and the refractory material after the applying of the one or more intumescent and refractory materials. In accordance with some embodiments, the method can include drying one or more the intumescent material and the refractory material after the applying of the one or more intumescent and refractory materials. In some embodiments, the method can include curing one or more the intumescent material and the refractory material after the applying of the one or more intumescent and refractory materials. In accordance with some embodiments, the method can further include when the intumescent material is applied on the first side and wherein the refractory material is applied on the second side; providing an electrochemical cell and mounting the thermal isolation material on the electrochemical where the refractory material is positioned nearer to and adjacent to the electrochemical cell and where the intumescent material faces outward and is further away from electrochemical cell than the refractory material.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples. Further features and advantages will become apparent from the following, more detailed, description of the various embodiments of the invention(s), as illustrated by the drawings referenced below.

FIG. 1A depicts a thermal isolation material composition according to some of the embodiments of the present disclosure;

FIG. 1B depicts a thermal isolation material composition according to some of the embodiments of the present disclosure;

FIG. 1C depicts a thermal isolation material composition according to some of the embodiments of the present disclosure;

FIG. 2A depicts a thermal isolation material composition according to some of the embodiments of the present disclosure;

FIG. 2B depicts a thermal isolation material composition according to some of the embodiments of the present disclosure;

FIG. 2C depicts a thermal isolation material composition according to some of the embodiments of the present disclosure;

FIG. 2D depicts a thermal isolation material composition according to some of the embodiments of the present disclosure;

FIG. 2E depicts a thermal isolation material composition according to some of the embodiments of the present disclosure;

FIG. 2F depicts a thermal isolation material composition according to some of the embodiments of the present disclosure;

FIG. 2G depicts a thermal isolation material composition according to some of the embodiments of the present disclosure;

FIG. 2H depicts a thermal isolation material composition according to some of the embodiments of the present disclosure;

FIG. 2I depicts a thermal isolation material composition according to some of the embodiments of the present disclosure;

FIG. 2J depicts a thermal isolation material composition according to some of the embodiments of the present disclosure;

FIG. 2K depicts a thermal isolation material composition according to some of the embodiments of the present disclosure;

FIG. 2L depicts a thermal isolation material composition according to some of the embodiments of the present disclosure;

FIG. 2M depicts a thermal isolation material composition according to some of the embodiments of the present disclosure;

FIG. 3 depicts a test device according some embodiments of the present disclosure;

FIG. 4 depicts the device of FIG. 3 during some of the tests conducted according to some of the embodiments of the present disclosure;

FIG. 5 depicts the device of FIG. 3 during some of the tests conducted according to some of the embodiments of the present disclosure;

FIG. 6A depicts a portion of test device of FIG. 3 according to some of the embodiments of the present disclosure;

FIG. 6B depicts a portion of test device of FIG. 3 according to some of the embodiments of the present disclosure;

FIG. 7 depicts thermal data for some the tests conducted according to some of the embodiments of the present disclosure;

FIG. 8 depicts thermal data for some the tests conducted with the thermal isolation material according to some of the embodiments of the present disclosure;

FIG. 9A depicts thermal data for some the tests conducted with and with the thermal isolation material according to some of the embodiments of the present disclosure;

FIG. 9B depicts thermal data for some the tests conducted with and with the thermal isolation material according to some of the embodiments of the present disclosure;

FIG. 10A depicts a thermal isolation material composition according to some of the embodiments of the present disclosure;

FIG. 10B depicts a thermal isolation material composition according to some of the embodiments of the present disclosure;

FIG. 11 depicts thermal data for some the tests conducted without the thermal isolation material according to some of the embodiments of the present disclosure;

FIG. 12 depicts thermal data for some the tests conducted with the thermal isolation material according to some of the embodiments of the present disclosure;

FIG. 13 depicts a process of making the thermal isolation material according to some of the embodiments of the present disclosure;

FIG. 14A depicts a thermal isolation material composition according to some of the embodiments of the present disclosure;

FIG. 14B depicts a thermal isolation material composition according to some of the embodiments of the present disclosure; and

FIG. 14C depicts a thermal isolation material composition according to some of the embodiments of the present disclosure.

### DETAILED DESCRIPTION

These and other needs are addressed by the present disclosure. In accordance with some embodiments of the present disclosure is a thermal isolation material 100 comprising a refractory material 120, an intumescent material 110, and a substrate 130. Some embodiments can include a phase change material 140.

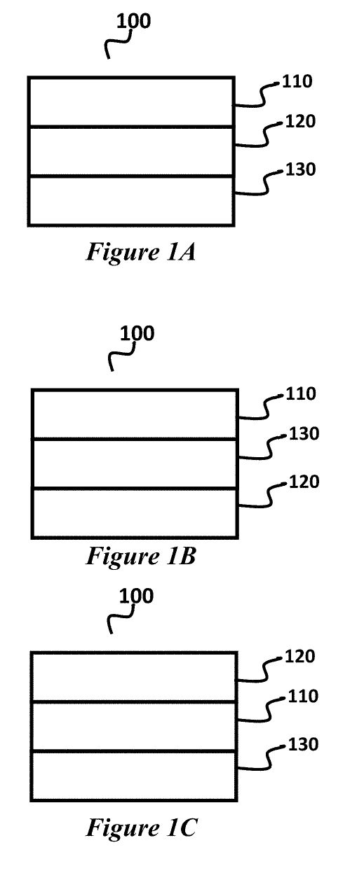

In accordance with some embodiments, the refractory material 120, the intumescent material 110, and the substrate 130 can be stacked one on top of the other. In some embodiments, thermal isolation material 100 can have the refractory material 120 positioned between the intumescent material and the substrate 130 (FIG. 1A). In some embodiments, thermal isolation material 100 can have the substrate 130 positioned between the refractory material 120 and the intumescent material 110 (FIG. 1B). In some embodiments, thermal isolation material 100 can have the intumescent material 110 positioned between the refractory material 120 and the substrate 130 (FIG. 1C).

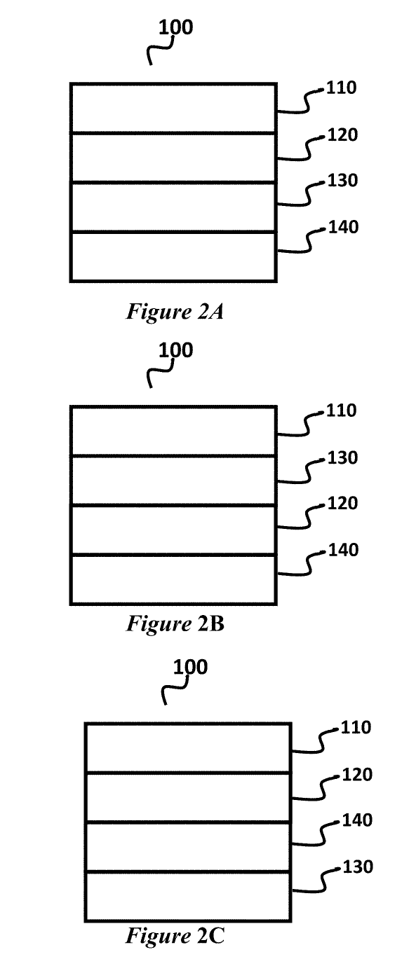

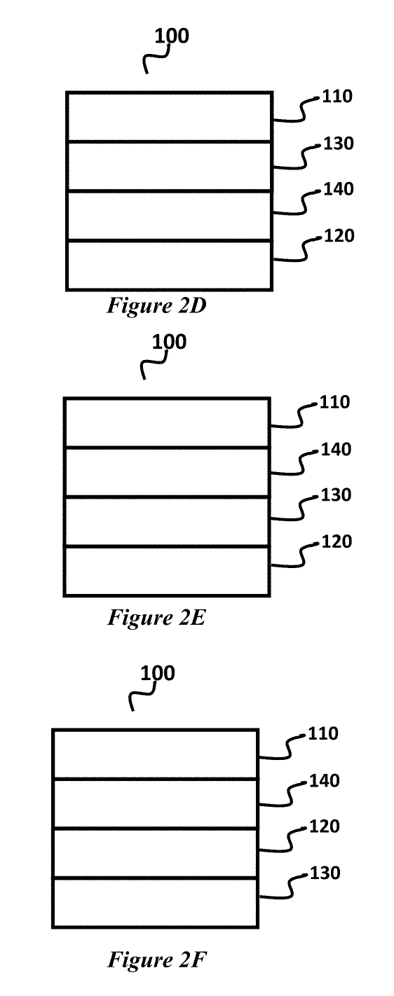

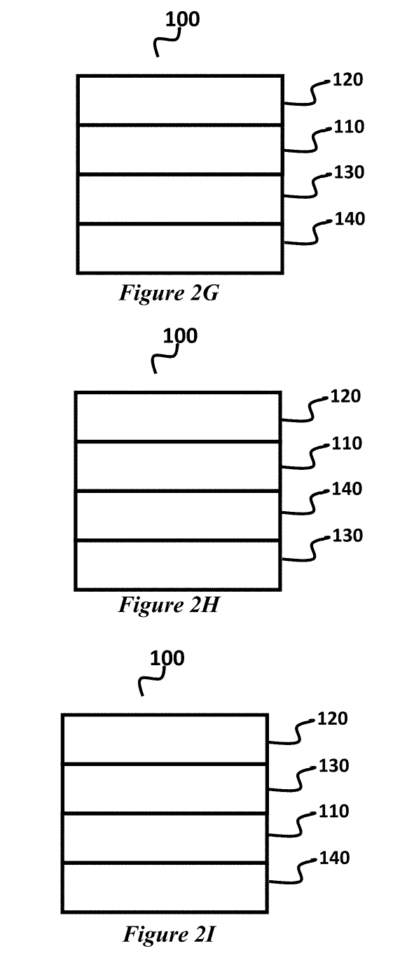

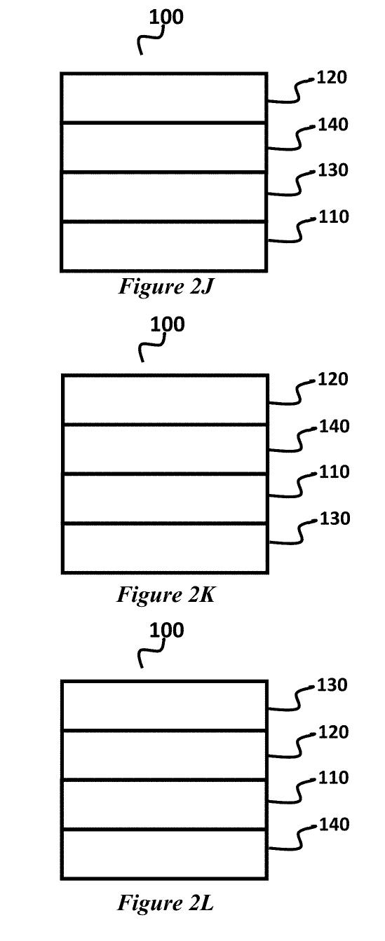

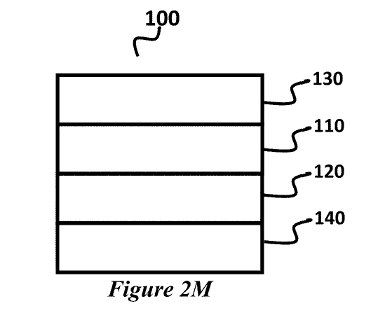

In accordance with some embodiments, the refractory material 120, the intumescent material 110, the phase change material 140, and the substrate can be stacked one on top of the other. In some embodiments, thermal isolation material 100 can have the refractory material 120 positioned between the intumescent material 110 and the substrate 130, with the substrate 130 positioned between the refractory material 120 and the phase change material 140 (FIG. 2A). In some embodiments, thermal isolation material 100 can have the substrate 130 positioned between the intumescent material 110 and the refractory material 120, with the refractory material 120 positioned between the substrate 130 and the phase change material 140 (FIG. 2B). In some embodiments, thermal isolation material 100 can have the refractory material 120 positioned between the intumescent material 110 and the phase change material 140, with the phase change material 140 positioned between the refractory material 120 and the phase change material substrate 130 (FIG. 2C). In some embodiments, thermal isolation material 100 can have the substrate 130 positioned between the intumescent material 110 and the phase change material 140, with the phase change material 140 positioned between the substrate 130 and the phase change material refractory material 120 (FIG. 2D). In some embodiments, thermal isolation material 100 can have the phase change material 140 positioned between the intumescent material 110 and the substrate 130, with the substrate 130 positioned between the phase change material 140 and the phase change material refractory material 120 (FIG. 2E). In some embodiments, thermal isolation material 100 can have the phase change material 140 positioned between the intumescent material 110 and the refractory material 120, with the refractory material 120 positioned between the phase change material 140 and the phase change material substrate 130 (FIG. 2F). In some embodiments, thermal isolation material 100 can have the intumescent material 110 positioned between the refractory material 120 and the substrate 130, with the substrate 130 positioned between the intumescent material 110 and the phase change material 140 (FIG. 2G). In some embodiments, thermal isolation material 100 can have the intumescent material 110 positioned between the refractory material 120 and the phase change material 140, with the phase change material 140 positioned between the intumescent material 110 and the phase change material substrate 130 (FIG. 2H). In some embodiments, thermal isolation material 100 can have the substrate 130 positioned between the refractory material 120 and the intumescent material 110, with the intumescent material 110 positioned between the substrate 130 and the phase change material phase change material 140 (FIG. 2I). In some embodiments, thermal isolation material 100 can have the phase change material 140 positioned between the refractory material 120 and the substrate 130, with the substrate 130 positioned between the phase change material 140 and the phase change material intumescent material 110 (FIG. 2J). In some embodiments, thermal isolation material 100 can have the phase change material 140 positioned between the refractory material 120 and the intumescent material 110, with the intumescent material 110 positioned between the phase change material 140 and the phase change material substrate 130 (FIG. 2K). In some embodiments, thermal isolation material 100 can have the refractory material 120 positioned between the substrate 130 and the intumescent material 110, with the intumescent material 110 positioned between the refractory material 120 and the phase change material phase change material 140 (FIG. 2L). In some embodiments, thermal isolation material 100 can have the intumescent material 110 positioned between the substrate 130 and the refractory material 120, with the refractory material 120 positioned between the intumescent material 110 and the phase change material phase change material 140 (FIG. 2M).

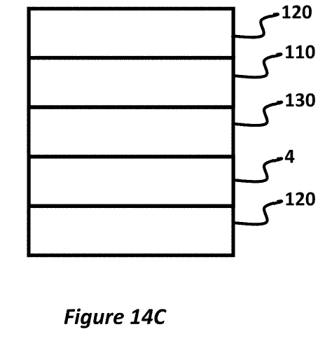

In some embodiments, the thermal isolation material 100 can comprise the refractory material 120 positioned between the intumescent material 110 and substrate 130 on one side of the substrate and on the opposing side of the substrate having the refractory material 120 positioned between the intumescent material 110 and the substrate 130 (FIG. 14A). In some embodiments, the thermal isolation material 100 can comprise the refractory material 120 positioned between the intumescent material 110 and substrate 130 on one side of the substrate and on the opposing side of the substrate having the intumescent material 110 positioned between the refractory material 120 and the substrate 130 (FIG. 14B). In some embodiments, the thermal isolation material 100 can comprise the intumescent material 110 positioned between the refractory material 120 and substrate 130 on one side of the substrate and on the opposing side of the substrate having the intumescent material 110 positioned between the refractory material 120 and the substrate 130 (FIG. 14C).

The thermal isolation material 100 can have opposing first 191 and second 192 thermal isolation surfaces. In some embodiments, the first thermal isolation surface can comprise the intumescent material 110 and the second thermal isolation surface can comprise the refractory material 120. In some embodiments, the first thermal isolation surface can comprise the intumescent material 110 and the second thermal isolation surface can comprise the substrate 130. In some embodiments, the first thermal isolation surface can comprise the intumescent material 110 and the second thermal isolation surface can comprise the phase change material 140. In some embodiments, the first thermal isolation surface can comprise the refractory material 120 and the second thermal isolation surface can comprise the intumescent material 110. In some embodiments, the first thermal isolation surface can comprise the refractory material 120 and the second thermal isolation surface can comprise the substrate 130. In some embodiments, the first thermal isolation surface can comprise the refractory material 120 and the second thermal isolation surface can comprise the phase change material 140.

In some embodiments, the first thermal isolation surface can comprise the substrate 130 and the second thermal isolation surface can comprise the refractory material 120. In some embodiments, the first thermal isolation surface can comprise the substrate 130 and the second thermal isolation surface can comprise the intumescent material 110. In some embodiments, the first thermal isolation surface can comprise the substrate 130 and the second thermal isolation surface can comprise the phase change material 140.

In some embodiments, the first thermal isolation surface can comprise the phase change material 140 and the second thermal isolation surface can comprise the refractory material 120. In some embodiments, the first thermal isolation surface can comprise the phase change material 140 and the second thermal isolation surface can comprise the substrate 130. In some embodiments, the first thermal isolation surface can comprise the phase change material 140 and the second thermal isolation surface can comprise the intumescent material 110.

The intumescent material and/or intumescent material layer 110 can commonly one or more of isolate and absorb thermal energy. More commonly, the intumescent material and/or intumescent material layer 110 can commonly one or more of isolate and absorb the thermal energy generated by a flame. Moreover, the intumescent material and/or intumescent material layer 110 can provide thermal protection when one or more of the refractory material 120, substrate 130, and phase change material 140 of the thermal isolation material are damaged. The damage to one or more of the refractory material 120, substrate 130, and phase change material 140 can be in the form of a void, crack, aperture, tear, rip, or any combination thereof.

The refractory material layer 120 can comprise a binder. The binder can be an aqueous binder. The binder can be a hydrophilic binder. The binder can assist the refractory material 120 to bond to the one or more of the intumescent material and/or intumescent material layer 110, the substrate and/or substrate layer 130, and the phase change material and/or phase change layer 140. The refractory material layers 120 comprising the refractory material and binder generally one or more flake less and delaminate less than refractory material layers 120 lacking a binder. The refractory material layers 120 comprising the refractory material and binder are usually one or more bendable and flexible than refractory material layers 120 lacking a binder. The refractory material layers 120 comprising the refractory material and binder typically one or more flake less and delaminate less and are usually one or more of more bendable and more flexible than refractory material layers 120 lacking a binder. The refractory material layer 120 can comprise one or more of an adhesion and cohesion promoter. A non-limiting example of the one or more adhesion and cohesion promoter is oxalic acid. The binder can comprise without limitation a styrene butadiene rubber. In some embodiments, the binder can comprise without limitation a styrene butadiene rubber latex. Typically, the binder can be a modified styrene butadiene copolymer. More typically, the binder is a hydrophilic binder comprising a modified styrene butadiene copolymer. In some embodiments, the binder can be a polyvinylidene latex binder. In some embodiments, the binder can be a polyvinylidene fluoride-based latex binder.

In some embodiments, the substrate and/or substrate layer 130 can be a metal film and/or metal foil. The metal substrate and/or metal substrate layer 130 can be heat shield. The heat shield can deflect a flame impinging on one or more of the thermal isolation material 100 and the metal substrate and/or metal substrate layer 130. Moreover, in some embodiments, the metal substrate and/or metal substrate layer 130 can be one or more of a protective and a heat-dissipating layer. In some embodiments, the metal substrate and/or metal substrate layer 130 can cool a heated thermal isolation material 100. A heated thermal isolation material 100 generally refers to a thermal isolation material 100 having a temperature above the surrounding ambient temperature. In some embodiments, the metal substrate and/or metal substrate layer 130 can cool one or more of the intumescent material and/or intumescent material layer 110, the refractory material and/or refractory material layer 120, and the phase change material and/or phase change layer 140.

In accordance with some embodiments of the present disclosure is a thermal isolation material 100 generally having a thermal isolation material thickness from about 10 to about 1,000 micrometers. More generally, the thermal isolation material can have a thermal isolation material thickness from about 50 to about 250 micrometers. It can be appreciated that the thermal isolation material can have in some embodiments a thickness of no more than about 40,000 micrometers.

In some embodiments, the thermal isolation material can be substantially one or more of flexible and bendable. The thermal isolation material can be generally flexible and/or bendable around a radii of curvature of 10 mm or more diameter without one or more of substantial delamination and deterioration of one or more of the intumescent material 110, refractory material 120, substrate 130, and phase change material 140.

In accordance with some embodiments, the intumescent material and/or intumescent material layer 110 can have an intumescent material and/or intumescent material layer thickness of one of commonly no more than about 12,500 micrometers, more commonly of no more than about 6,400 micrometers, even more commonly of no more than about 3,200 micrometers, yet even more commonly of no more than about 1,600 micrometers, still yet even more commonly of no more than about 800 micrometers, still yet even more commonly of no more than about 400 micrometers, or yet still even more commonly of no more than about 200 micrometers, and typically an intumescent material and/or intumescent material layer thickness of about 800 micrometers or more, more typically of about 400 micrometers or more, even more typically of about 200 micrometers or more, yet even more typically of about 100 micrometers or more, still yet even more typically of about 50 micrometers or more, still yet even more typically of about 25 micrometers or more, or yet still even more typically of about 10 micrometers or more. In some embodiments, the intumescent material, or intumescent material layer, 110 can generally have an intumescent material and/or intumescent material layer thickness of one of no more than about 12,500 micrometers, more generally of no more than about 6,400 micrometers, even more generally of no more than about 3,200 micrometers, yet even more generally of no more than about 1,600 micrometers, still yet even more generally of no more than about 800 micrometers, still yet even more generally of no more than about 400 micrometers, still yet even more generally of no more than about 200 micrometers, still yet even more generally of no more than about 100 micrometers, still yet even more generally of no more than about 50 micrometers, still yet even more generally of no more than about 25 micrometers, or yet still even more generally of no more than about 10 micrometers. It can be appreciated that the intumescent material, or intumescent material layer, 110 can have an intumescent material and/or intumescent material layer thickness of more than about 0.1 micrometers.

In accordance with some embodiments, the refractory material and/or refractory material layer 120 can have a refractory material and/or refractory material layer thickness of one of usually no more than about 12,500 micrometers, more usually of no more than about 6,400 micrometers, even more usually of no more than about 3,200 micrometers, yet even more usually of no more than about 1,600 micrometers, still yet even more usually of no more than about 800 micrometers, still yet even more usually of no more than about 400 micrometers, or yet still even more usually of no more than about 200 micrometers, and generally a refractory material and/or refractory material layer thickness of about 800 micrometers or more, more generally of about 400 micrometers or more, even more generally of about 200 micrometers or more, yet even more generally of about 100 micrometers or more, still yet even more generally of about 50 micrometers or more, still yet even more generally of about 25 micrometers or more, or yet still even more generally of about 10 micrometers or more. In some embodiments, the refractory material, or refractory material layer, 120 can commonly have a refractory material and/or refractory material layer thickness of one of no more than about 12,500 micrometers, more commonly of no more than about 6,400 micrometers, even more commonly of no more than about 3,200 micrometers, yet even more commonly of no more than about 1,600 micrometers, still yet even more commonly of no more than about 800 micrometers, still yet even more commonly of no more than about 400 micrometers, still yet even more commonly of no more than about 200 micrometers, still yet even more commonly of no more than about 100 micrometers, still yet even more commonly of no more than about 50 micrometers, still yet even more commonly of no more than about 25 micrometers, or yet still even more commonly of no more than about 10 micrometers. It can be appreciated that the refractory material, or refractory material layer, 120 can have a refractory material and/or refractory material layer thickness of more than about 0.1 micrometers.

In accordance with some embodiments, the substrate and/or substrate layer 130 can have a substrate thickness and/or substrate layer thickness of one of generally no more than about 1,600 micrometers, more generally of no more than about 800 micrometers, even more generally of no more than about 400 micrometers, or yet even more generally of no more than about 400 micrometers, and a substrate thickness and/or substrate thickness of one of usually about 100 micrometers or more, more usually of about 50 micrometers or more, even more usually of about 25 micrometers or more, or yet even more usually of about 10 micrometers or more. In some embodiments, the substrate or substrate layer 130 can typically have a thickness of no more than about 1,600 micrometers, more usually of no more than about 800 micrometers, even more usually of no more than about 400 micrometers, yet even more usually of no more than about 200 micrometers, still yet even more usually of no more than about 100 micrometers, still yet even more usually of no more than about 50 micrometers, still yet even more usually of no more than about 25 micrometers, or yet still even more usually no more than about 10 micrometers. It can be appreciated that the substrate or substrate layer 130 can have a substrate and/or substrate thickness of more than about 0.1 micrometers.

In accordance with some embodiments, the phase change material and/or phase change material layer 140 can have a phase change material and/or phase change material thickness of one of typically no more than about 12,500 micrometers, more typically of no more than about 6,400 micrometers, even more typically of no more than about 3,200 micrometers, yet even more typically of no more than about 1,600 micrometers, still yet even more typically of no more than about 800 micrometers, still yet even more typically of no more than about 400 micrometers, or yet still even more typically of no more than about 200 micrometers, and commonly a phase change material and/or phase change material thickness of about 800 micrometers or more, more commonly of about 400 micrometers or more, even more commonly of about 200 micrometers or more, yet even more commonly of about 100 micrometers or more, still yet even more commonly of about 50 micrometers or more, still yet even more commonly of about 25 micrometers or more, or yet still even more commonly of about 10 micrometers or more. In some embodiments, the phase change material, or phase change material layer, 140 can usually have a phase change material and/or phase change material thickness of one of no more than about 12,500 micrometers, more usually of no more than about 6,400 micrometers, even more usually of no more than about 3,200 micrometers, yet even more usually of no more than about 1,600 micrometers, still yet even more usually of no more than about 800 micrometers, still yet even more usually of no more than about 400 micrometers, still yet even more usually of no more than about 200 micrometers, still yet even more usually of no more than about 100 micrometers, still yet even more usually of no more than about 50 micrometers, still yet even more usually of no more than about 25 micrometers, or yet still even more usually of no more than about 10 micrometers. It can be appreciated that the phase change material, or phase change material layer, 140 can have a phase change material and/or phase change material layer thickness of more than about 0.1 micrometers.

It can be appreciated that the intumescent material and/or intumescent material layer 110 can be one or more be free, devoid, and/or lack one or more of voids, channels, apertures, cracks, crevices or any combination thereof.

It can be appreciated that the refractory material, or refractory material layer, 120 can be one or more be free, devoid, and/or lack one or more of voids, channels, apertures, cracks, crevices or any combination thereof.

It can be appreciated that the substrate or substrate layer 130 can be one or more be free, devoid, and/or lack one or more of voids, channels, apertures, cracks, crevices or any combination thereof.

It can be appreciated that the phase change material, or phase change material layer, 140 can be one or more be free, devoid, and/or lack one or more of voids, channels, apertures, cracks, crevices or any combination thereof.

When exposed to thermal energy, the intumescent layer 110 can expand to produce a char layer. The char layer can have insulative properties. That is, the char layer can be a thermal insulator. Moreover, the char layer thickness can vary depending on one or more of the degree, extent, and period of thermal energy exposure. Generally, the char layer thickness increases with greater levels of thermal energy applied to the intumescent material and/or intumescent material layer 110. Also, the char layer thickness usually increases with longer periods of time of exposure of the applied thermal energy.

The intumescent material 110 can be any material that, when exposed to thermal energy, undergoes a chemical reaction that results in one or more of expansion and charring of the intumescent material 110 which can generally result in a heat insulating char. Typically, the intumescent material 110 when exposed to thermal energy swells and chars. The swelled char, compared to unchared intumescent material 110, generally has an increased volume. The increase in volume typically decreases the density of the intumescent material 110. The heat insulating char can be a hard insulating or a soft insulating char. The heat insulating char can be a high or low expansion char. It can be appreciated that, a hard, insulating char can be a high or low expansion, hard-insulating char. Similarly, a soft insulating char can be a high or low expansion, low insulating char. Moreover, the low expansion, low insulating char can be one of a water-base, solvent-based, or epoxy-based intumescent material 110. While not wanting to be limited by example, soft char intumescent materials produce a char that is a poor conductor of heat. The soft char can retard heat transfer. The char can be dense and robust (hard char) or light with lots of air (soft char). Low expansion char generally produces a thin char layer, while high expansion char commonly produces a char layer thicker than the base intumescent material thickness.

In some embodiments, the char can comprise a microporous carbonaceous foam. The microporous carbonaceous foam is generally formed by a chemical reaction of components comprising the intumescent material 110. In some embodiments, the intumescent material 110 comprises ammonium polyphosphate, pentaerythritol, and melamine. This reaction of the intumescent material 110 components can take place in a matrix formed by the molten binder. The molten binder typically comprises one or more of vinyl acetate copolymer, styrene acrylate, a combination thereof, and a mixture thereof. In some embodiments, the intumescent material 110 can contain hydrates. The hydrate containing coatings, when subjected to thermal energy, can release water vapor. The water vapor can be released one or more of prior to, during, or prior to and during the char formation. In some embodiments, hard chars are produced with compositions containing one or more of sodium silicates and graphite.

In some embodiments, the intumescent material 110 can be an epoxy-based intumescent material 110. In some embodiments, intumescent material 110 can be one of FIRE SAFE PRODUCTS, INC. FX-100™ and CARBOLINE THERMOLAG™ 3000 SA.

The FX-100 intumescent coating system can comprise an amine phosphate polymer. The amine phosphate polymer can be an aqueous-based system. Typically, the aqueous-based amine phosphate polymer can comprise from about 50 to about 65 wt % of the intumescent coating system. The intumescent coating system can also include one or more coating additives. The one or more coating additives can comprise from about 5 to about 20 wt % of the intumescent coating system. Accordingly, the intumescent coating system can contain from about 15 to about 40 wt % water. The intumescent coating system is generally combined with a curing agent. More generally, the 4 parts by volume of the intumescent coating system is mixed with one part by volume of the curing agent. The curing agent generally comprises an alkylated melamine formaldehyde resin. More generally, the curing agent comprises an aqueous mixture of alkylated melamine formaldehyde reins. In some embodiments, the curing agent can contain small amounts of isopropanol and formaldehyde. Typically, the curing agent can have no more than about 2 wt % each of isopropanol and formaldehyde. The curing agent can also contain methanol. Usually, the curing agent can contain no more than about 0.3 wt % methanol. In some embodiments, the intumescent material 110 and/or intumescent layer 110 can comprise an adhesion promoter. The adhesion promoter can be applied to the substrate 120 prior to containing of the intumescent coating system with the substrate 130. The adhesion promoter can comprise a mixture of an amine phosphate polymer and a vinyl-acrylic latex. The adhesion promoter can be an aqueous-based mixture of the amine phosphate polymer and vinyl-acrylic polymer. In some embodiments, the adhesion promoter can include boric acid. Generally, the adhesion promoter can include no more than about 1 wt % boric acid. Commonly, the adhesion promoter contains from about 45 to about 55 wt % of an aqueous-based amine phosphate polymer. More commonly, the adhesion promoter contains about 20 to 30 wt % of the amine phosphate polymer. Typically, the adhesion promoter contains from about 40 to about 50 wt % of vinyl-acrylic latex. More typically, the adhesion promoter contains from about 20 to about 30 wt % of the vinyl-acrylic polymer. When exposed to one or more of heat and flame, the intumescent material can release one or more of water and carbon dioxide. It is believed that the one or more of the released water and carbon dioxide can one or more of cool and extinguish the heat and/or flame. After mixing the curing agent with the intumescent coating system, the mixture can be cured. In some embodiments, decreasing the humidity level in the curing environment can decrease the curing time. Moreover, moving air across the surface of intumescent material layer can also decrease curing time. The curing time can also be decrease by curing the intumescent material layer at a temperature above the ambient temperature. For example, temperatures from about 25 to about 35 degrees Celsius can increase the rate of cutting and thereby decrease cure time. Moreover, heating the intumescent coating system to a temperature of from about 30 to about 38 degrees Celsius when mixing with curing agent (added at ambient temperature) can one or more of reduce the viscosity of the mixture and reduce time tack time. For lower viscosity mixtures or thin layer applications, the intumescent coating system and water can be heated generally to about 50 to about 70 degrees Celsius, more generally to about 54 to about 66 degrees Celsius, before combining the intumescent coating system and water. Commonly, about heated water is added by about 5% by weight increments, but not to exceed from about 20 to about 25% by weight. When the intumescent coating material viscosity is reduced in this matter the amount of curing agent added is based on volume of amine phosphate polymer. Typically, the amine phosphate polymer dries very rigid over a period of several weeks to several months. As such, it is not generally not suitable for flexible panels and applications or ones that incur marked temperature expansion and contraction; therefore, its application usually includes one or more of use with a refractory material as described herein, application as a thin layer as described herein, and with additional additives as described herein.

In some embodiments, the intumescent material 110 can comprise a 100% solids epoxy based intumescent material 110 designed to fireproof steelwork for up to a four-hour fire rating. A 100% solids coating generally refers to a liquid material that will change from a liquid to a solid without a substantial loss in mass. Typically, a 100% solids coating contains either no solvent or a trace amount of solvent from the manufacturing process. An epoxy intumescent material 110 usually comprises an organic binder resin, such as an epoxy, and an acid catalyst, such as without limitation ammonium polyphosphate. The ammonium polyphosphate decomposes when subjected to thermal energy to yield a mineral acid. The mineral acid produced, can react with a carbonific source, for example, pentaerythritol, to produce a carbon char. The intumescent material 110 can include a spumific (foam-producing) agent, such as without limitation a melamine. The spumific agent can react with the acid source and decompose. This decomposition product can generate an inert gas that expands the char. It can be appreciated that, although more complex processes can also occur beyond these basic reactions. For example, filler particles can be incorporated into the intumescent material 110 to act as nucleating sites or “bubble growth” sites. It can also be appreciated that the organic binder resin, such as the epoxy, can affect one or more of the softening and charring of the intumescent material 110. Furthermore, different resins can be used in the formulation of an intumescent material 110.

In some embodiments, the intumescent material 110 can be prepared according to the recommendations of the manufacturer. In some embodiments, the intumescent material 110 can be prepared with any suitable solvent to reduce one or more of the viscosity and surface tension of the intumescent material 110 for one or more of pouring and spreading. After spreading the intumescent layer 110 substantially evenly on the substrate 130, the intumescent layer 110 is typically cured. The cure time can be one of generally about 0.1 day, more generally about 0.2 day, even more generally about 0.3 day, yet even more generally about 0.5 day, still yet even more generally 0.75 days, still yet even more generally 1 day, still yet even more generally 1.25 days, still yet even more generally 1.75 days, still yet even more generally 2 days, still yet even more generally 2.5 days, or yet still even more generally 3 days. The cured intumescent layer 110 thickness is usually sufficient to provide the necessary thermal rating protection, in minutes of protection. The thermal protection rating is commonly one of about 15 minutes, more commonly about 20 minutes, even more commonly about 30 minutes, yet even more commonly about 45 minutes, still yet even more commonly about 60 minutes, still yet even more commonly about 80 minutes, still yet even more commonly about 90 minutes, or yet still even more commonly about 120 minutes.

The refractory material 120 can comprise any material that maintains its strength at high temperatures. The refractory material 120 is usually a thermal insulator material. The thermal insulator can act as a thermal insulation shield.

High temperature for a refractory material 120 generally refers to a temperature of one of no more than about 3,500 degrees Celsius, more generally no more than about 3,000 degrees Celsius, even more generally no more than about 2,500 degrees Celsius, yet even more generally no more than about 2,000 degrees Celsius, still yet even more generally no more than about 1,500 degrees Celsius, or yet still even more generally no more than about 1,000 degrees Celsius, and typically one of more than about 1,000 degrees Celsius, even more typically more than about 900 degrees Celsius, yet even more typically more than about 500 degrees Celsius, still yet even more than about 200 degrees Celsius, still yet even more than about 100 degrees Celsius, or yet still more than about 60 degrees Celsius. In some embodiments, the refractory material 120 can be a ceramic fiber-based refractory material. In general, the ceramic fiber-based refractory material is a lightweight insulating material having one of more of a low thermal mass (which means that it does not retain heat), a low thermal conductivity and a high thermal shock resistance. The ceramic fiber-based refractory material can be an extremely effective insulation material. The ceramic fiber-based refractory material is typically suitable for applications where traditional refractory materials cannot be used. Typically, the ceramic fiber-based refractory material can comprise high purity alumino-silicate materials. Ceramic fibers are generally produced by melting high purity alumino-silicate materials in an electric arc furnace. A melt stream is poured for the electric arc furnace and cooled to form the fiber strands from which the ceramic fiber-based refractory material is produced. The ceramic fiber-based refractory material is generally substantially free of asbestos. The fiber strands can be combined with one or more binding materials to form a ceramic fiber-based paper or felt. These ceramic fiber-based papers or felts commonly melt at about 1,800 degrees Celsius. Moreover, these ceramic fiber-based paper or felts are generally suitable as thermal insulators up to temperatures of about 1,260 degrees Celsius, more generally up to about 1,300 degrees Celsius. The fiber-based refractory material can be in the form of board, blanket, coating, tile, brick, textile, paper, felt or combination thereof. In some embodiments, the ceramic fiber-based refractory material can comprise a refractory paper, felt, or combination thereof. In some embodiments, the ceramic fiber-based refractory material can provide superior thermal insulation by restricting heat transfer. In some embodiments, the fiber-based refractory material can be comprised of FIBERFRAX™ QF-180.

The phase change material 140 can comprise one or more of organic phase change material, an inorganic phase change material, a eutectic phase change material or mixture, a hydroscopic material, a combination and/or mixture thereof. Non-limiting examples of suitable organic phase change materials are paraffinic materials (CₙH₂ₙ₊₂), carbonates, and lipids. Inorganic phase change materials can comprise without limitation salt hydrates. Non-limiting examples of suitable salt hydrates are alkali salt hydrates, alkaline earth salt hydrates, transition metal salt hydrates, Group 13 (of the periodic table) metal salt hydrates, Group 14 salt hydrates, and combinations and mixtures thereof. These hydroscopic materials can absorb and release water. The absorption of water is an exothermic process that gives off heat (that is the enthalpy decreases), while the release of water is an endothermic process that absorbs heat (or cools as the enthalpy increases). The eutectic materials can comprise organic materials, inorganic materials or mixtures thereof.

The substrate 130 can be an inorganic or organic material. Non-limiting examples of inorganic substrates are metal foils and inorganic composite films. The metal foil can be without limitation metal or alloy foil of one or more of a Group 3 through Group 15 metal, alloy combination thereof. Moreover, the foil can be without limitation a metal or alloy foil of one or more of chromium, manganese, iron, cobalt, nickel, copper, zinc, molybdenum, silver, gold, aluminum, tin, lead, or combination or alloy thereof. While not wanting to be limited by example, the organic material can comprise a polymeric material.

Some embodiments of the present disclosure can be to effective cell isolation design for large-format batteries. Some embodiments can be to effective cell isolation design for large-format lithium ion batteries.

Current methods of cell isolation are ineffective, resulting in potentially hazardous events, such as, when crushed, overcharged, discharged, high temperatures, and internal short circuits. In the event of cell failure, the damaged cell can propagation heat. The heat from the defective and/or damaged cell can propagate to the surrounding cells in a battery pack, leading to a “domino-effect”, resulting in a thermal runaway. The National Transportation Safety Board has detailed the failure modes of battery packs, and point to the need for more robust cell isolation. It specifically demonstrates that encompassing cells with an insulation material is an insufficient means of preventing cell-to-cell thermal runaway and subsequent deflagration.

Thermal insulation alone is ineffective in preventing pack deflagration. When a compromised cell undergoes thermal runaway, events occurring above about 120 degrees Celsius, the event is often quick, practicality instantaneous, and therefore does not allow time for effective thermal insulation of adjacent cells if they are not properly isolated. Prior to thermal runaway, at temperatures of about 50 to about 120 degrees Celsius, the heat rise can be slower and therefore propagate to adjacent cells. However, the heat rise and temperatures seen by adjacent cells prior to thermal runaway is comparatively benign to thermal runaway. If an uncompromised adjacent cell is exposed to modest temperature increases, below about 120 degrees Celsius, it is unlikely to undergo thermal runaway. On the other hand, if an uncompromised cell is exposed to a flame (temperatures much higher than about 120 degrees Celsius) and projectiles it is highly likely to undergo thermal runaway and propagation leading to pack deflagration.

Some embodiments of the present disclosure address this need. Some embodiments of this disclosure are to a low volume and mass efficient, layered thermal management system to mitigate thermal propagation risks. The thermal isolation material 100 can mitigate the likelihood and effects of a catastrophic event. Moreover, the thermal isolation material 100 can effectively mitigate a cascading failure compared to cells without the thermal isolation material 100. Additionally, thermal data of the examples show the effectiveness of the thermal isolation material 100 in reducing the transmission of large spikes in thermal energy to one or more adjacent cells when one or more cells in a module undergoes thermal runaway.

The thermal isolation material 100 of the present disclosure can be a safety device for electrochemical energy storage devices, among others. The thermal isolation material 100 can provide thermal isolation from an extreme set of thermal conditions. Non-limiting examples of such thermal conditions are direct propane flame impingement for a period of about 45 minutes. In some embodiments, the thermal isolation material 100 can be a layered material comprising an intumescent-coated 110 substrate 130 and a flexible ceramic refractory material 120. The substrate 130 can be a foil. In some embodiments, the thermal isolation material 100 can be one or more of a passive thermal insulation device and a fire protection device. Moreover, the thermal isolation device 100 can be one or more of a compact and mass efficient passive thermal insulation device and thermal protection device.

In accordance with some embodiments, the thermal isolation material 100 is easily integrated with existing electrochemical storage devices. Moreover, the thermal isolation device can enable safe and continuous operation of the electrochemical energy storage devices.

In some embodiments, the electrochemical storage device can be a high-energy lithium ion battery.

In accordance with some embodiments, the substrate 130 can be one or more of heat shield and projectile shield. The substrate 130 can also be a support of the intumescent material 110. The substrate 130 can in some embodiments be interconnected with an active cooling material. In some embodiments, one or more of an intumescent material layer 110 and a refractory material layer 120 can be applied on the substrate 130. The substrate 130 can be a foil. The foil can be one or more of heat shield and projectile shield. The foil can also be a support of the intumescent material 110. The foil can be in some embodiments interconnected with an active cooling material. In some embodiments, one or more of an intumescent material layer 110 and a refractory material layer 120 can be applied on the foil. The foil can be a metallic foil.

In accordance with some embodiments is a process for applying a refractory material 120 to the substrate 130. The process can include a modification of the substrate 130. The modification of the substrate 130 can be by etching. In some embodiments, a propane flame (at a temperature of about 1980 degrees Celsius) can etch the substrate 130. Moreover, a laboratory hot plate can modify the substrate by an etch the substrate 130. The process can include one or more of an etched copper foil. The modification of the substrate 130 is believed to improve adhesion of one or more intumescent material 110 and the refractory material 120. Etching of the copper foil is believed to enhance surface variation of surface properties for improved adhesion.

In some embodiments, the refractory material 120 can be Fiberfrax. Moreover, in some embodiments, the refractory material 120 can be in the form of a slurry. The slurry can be a water-based slurry. The water-based slurry can be comprised of Unifrax QF-180. Moreover, he slurry can comprise one or more aqueous binders. Typically, refractory material and/or refractory material layer is applied to the substrate 130 as a liquid having a viscosity of no more than about 10,000 cP. More commonly, the refractory material and/or refractory material layer is applied to the substrate 130 as a liquid comprising from about 0.1 to about 20 wt %, more commonly from about 2 to about 15 wt %, or even more commonly from about 1 to about 11 wt % binder, from about 0 to about 50 wt % water, and remainder being refractory material. The refractory material generally has one or more of an average particle size, a mean particle size, and a particle size mode of no more than about 20 microns, more generally of no more than about 15 microns, or even more generally of no more than about 10 microns. It can be appreciated that the one or more of the average particle size, mean particle size, and particle size mode can refer to any one of a P₅₀, P₆₀, P₇₀, P₇₅, P₈₀, P₈₅, P₉₀, or P₉₅. The refractory material and/or refractory material layer can comprise from about 40 to about 60 wt % aluminosilicate, from about 20 to about 50 wt % water, from about 10 to about 15 wt % amorphous silica, and from about 1 to about 3 wt % hydrated magnesium aluminum silicate minerals. Moreover, the aluminosilicate can comprise one or more of refractory ceramic fiber, alunino silicate wool, synthetic vitreous fiber, man-made vitreous fiber, man-made mineral fiber, and high temperature insulation wool. In some embodiments, the refractory material and/or refractory material layer can comprise from about 34 to about 40 wt % Al₂O₃, from about 56 to about 62 wt % SiO₂, from about 0.4 to about 1.0 wt % Na₂O, form about 0.1 to about 0.5 wt % MgO, from about 0.4 to about 1.0 wt % Fe₂O₃, from about 1.1 to about 1.7 wt % TiO₂, and from about 0.3 to about 0.9 wt % trace materials. In some embodiments, the refractory material and/or refractory material layer can comprise can have an operating temperature grade rating from about 2,150 to about 1,260 degrees Celsius. In some embodiments, the temperature grade rating is no more than about 2,150 degrees Celsius. In some embodiments, the temperature grade rating is no more than about 1,260 degrees Celsius. The refractory material and/or refractory material layer can have one or more of a mean coefficient of expansion of about 3×10⁻⁶ in/in/degrees Fahrenheit, a linear shrinkage (%) (24 hours) of about 3.2 @ 2,300 degrees Fahrenheit and a dielectric strength of about 39 volts/mil.

The ratio of the binder to refractory material can affect the application of the refractory material and/or refractory material lay 120 to the substrate 130. In some embodiments, the ratio of the binder to the refractory material one or more of flexibility and ability to meter the refractory material 120 mixed with binder to the substrate 130. Generally, the refractory material 120 is brittle. Combining the refractory material with a binder can improve one or more of adhesion and cohesion the refractory material layer 120. The binder can be a polymeric latex binder. The binder is typically combustible. Moreover, the binder commonly has one or more of a lower melting and decomposition temperature than the refractory material.

Commonly, the ratio of the slurry-based refractory material to a latex binder is about 99:1 (by mass) ratio, more commonly about 98:1, even more commonly about 95:1, yet even more commonly about 90:1, still yet even more commonly about 85:1, still yet even more commonly about 80:1, still yet even more commonly about 75:1, still yet even more commonly about 70:1, still yet even more commonly about 65:1, still yet even more commonly about 60:1, still yet even more commonly about 55:1, still yet even more commonly about 50:1, still yet even more commonly about 45:1, still yet even more commonly about 40:1, or yet still even more commonly 35:1. The ratio of the slurry-based refractory material with latex binder includes water. The slurry-based refractory material and the latex binder generally include different mass ratios of solids and water. Accordingly, in some embodiments, the water-based ratio of the refractory material 120 to binder can be greater than the dried ratio. In some embodiments, the water-based ratio of the refractory material 120 to binder can be no greater than the dried ratio.

In accordance with some embodiments, a greater percent of binder can improve one or more of the cohesion and adhesion of the refractory material 120. Without wanting to be limited by theory, it is believed that the greater one or more of the cohesion and adhesion and allows for a greater radius of curvature of the refractory material of 120. Moreover, the greater percent of binder can decrease one or more of the level of cracking and delamination of the refractory material 120.

In accordance with some embodiments, the refractory material layer 120 is degassed prior to drying. Degassing of the refractory material layer 120 reduces the heterogeneous nature of the coating layer. Degassing of the refractory material layer 120 reduces the level of air pockets and streaks within the coating layer.

The insulative property of the substrate 130, when heated by a laboratory hot plate, with and without refractory coating (about 462 micrometers) is shown in the Table 1 of the thermal isolation performance of a 462 micrometer thick refractory coating on a copper substrate. An infrared camera was utilized to perform this analysis. Even after about 3 minutes of propane flame impingement on a really thin (about 462 micrometers) layer of the refractory material 120 on the substrate 130 showed minimal physical damage compared to the physical deterioration of the substrate lacking a refractory layer 120. Further burn testing of the refractory lay showed refractory layers as thin as about 20 micrometers on a metal folio exhibited an increase in burn through time from under about 4 minutes to over 45 minutes upon direct impingement of a propane flame.

TABLE 1

| | Hot Plate | Insulation (Opposing Sides |
|---|---|---|
| Time | Temperature | Temperature Difference, |
| (sec) | (degrees Celsius) | degrees Celsius) |
| 30 | 53 | 6 |
| 60 | 154 | 61 |
| 90 | 230 | 100 |
| 120 | 284 | 101 |
| 150 | 361 | 139 |
| 180 | 394 | 137 |
| 240 | 471 | 141 |
| 270 | 513 | 146 |
| 300 | 545 | 164 |

Generally, for LiFePO₄ electrochemical cells, thermal runaway occurs at a temperature of about 320 to about 350 degrees Celsius. The thermal runaway is generally followed by a significant temperature jump.

In some embodiments, the thermal isolation material 100 can comprise an intumescent material layer 110 and a substrate 130. The substrate 130 can be a copper metal substrate. Generally, the copper substrate can be treated prior to application of the intumescent material layer 110. In some embodiments, the copper substrate has a thickness is commonly from about 10 to about 100 micrometers, more commonly of about 40 micrometers. In some embodiments, opposing sides of the copper substrate are treated. In some embodiments, the treated copper substrate is a grade 3 base foil with the treatment applied to both the first and second sides to promote adhesion. Moreover, in some embodiments, a refractory material layer 120 was applied to a first side of the substrate 130 and the intumescent material 110 was applied to a second side of substrate 130 with the first and second sides of the substrate 130 being in an opposing relationship. The thermal isolation material 100 having the intumescent material layer 110 on a first side of the substrate 130 and the refractory material layer 120 on second side of the substrate 130, the first and second sides in an opposing relationship, can comprise one or both of a low mass and low volume, flexible material for passive thermal isolation.

In accordance with some embodiments is a thermal isolation material 100 having the intumescent material layer 110 on a first side of the substrate 130 and the refractory material layer 120 on second side of the substrate 130, the first and second sides being in an opposing relationship, can comprise one or both of a low mass and low volume, flexible material for passive electrochemical cell thermal isolation. In some embodiments, the thermal isolation material 100 can have the refractory material layer 120 in contact with the electrochemical cell and the intumescent material layer 110 forming the outer wall of the electrochemical cell.

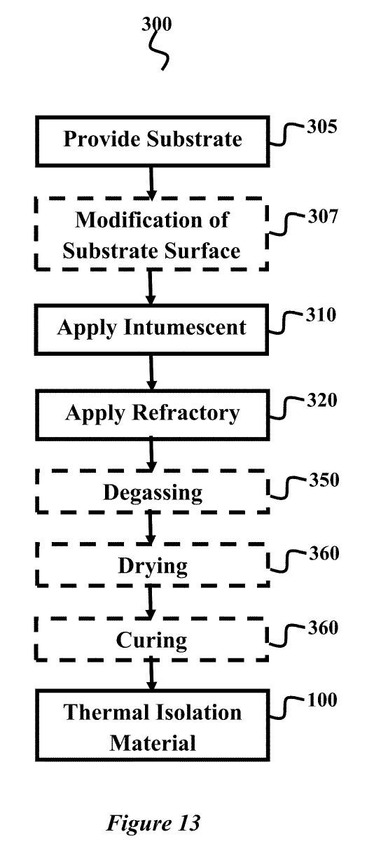

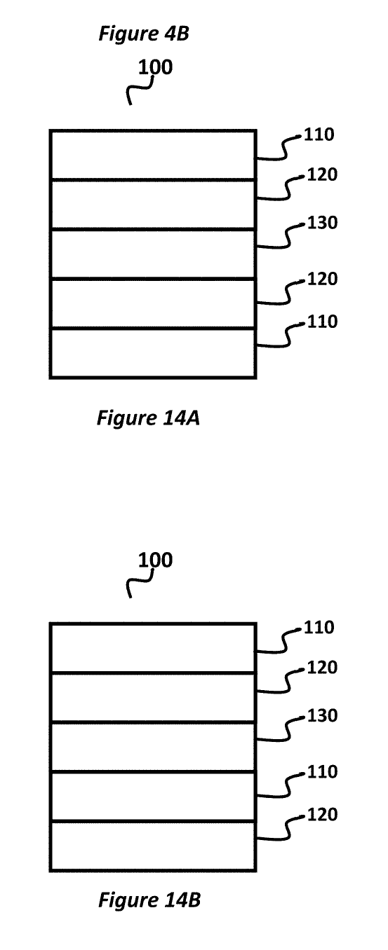

FIG. 13 depicts a process 300 for making a thermal isolation material 100.

In step 305, a substrate 130 is provided. The substrate 130 has opposing first and second sides. The substrate 130 can be provided with one or more of the first and second sides modified. The surface modification can be one or more of surface variation and addition of surface reactive groups. While not wanting to be limited by theory, it is believed that the one or more of surface variation and surface reactive groups can improve adhesion of one or more of the intumescent material 110 and/or intumescent material layer 110, the refractory material 120 and/or refractory material layer 120, and phase change material 140 and/or phase change material layer 140.

Some embodiments can include step 307. Step 307 can comprise a modification of one or more of the first and second surfaces of the substrate 130. In some embodiments, the surface modification can include introducing surface variation to one or more of first and second surfaces of the substrate 130. Non-limiting examples of processes for introducing surface variation are chemical and mechanical methods of etching a surface. In some embodiments, the surface modification can include forming surface reactive groups on the one or more first and second surfaces of the substrate 130. Non-limiting examples of processes for introducing surface reactive groups corona treatments, flame spraying, and chemical treatments to name a few.

In step 310, an intumescent material 110 and/or intumescent material layer 110 is applied to the substrate 130. The intumescent material 110 and/or intumescent material layer 110 can applied by any coating method. Examples, without limitation are kiss-rollers, curtain coating, mate application, drawn down bars, spray coating, screen coating, calendar coating, pad coating to name a few. The intumescent material can be mixed with one or more of a solvent, binder, adhesion promoter, rheology modifier, and combinations thereof.

In step 320, a refractory material 120 and/or refractory material layer 120 is applied to the substrate 130. The refractory material 120 and/or refractory material layer 120 can applied by any coating method. Examples, without limitation are kiss-rollers, curtain coating, mate application, drawn down bars, spray coating, screen coating, calendar coating, pad coating to name a few. The refractory material can be mixed with one or more of a solvent, binder, adhesion promoter, rheology modifier, and combinations thereof.

In some embodiments, step 310 can include contacting the intumescent material 110 and/or intumescent material layer 110 one of the first and second sides of the substrate 130. It can be appreciated that the one of the first and second sides of the substrate 130 can modified surface for improved adhesion of the intumescent material 110 and/or intumescent material layer 110 to the substrate 130.

In some embodiments, step 320 can include contacting the refractory material 120 and/or refractory material layer 120 one of the first and second sides of the substrate 130. It can be appreciated that the one of the first and second sides of the substrate 130 can modified surface for improved adhesion of the refractory material 120 and/or refractory material layer 120 to the substrate 130.

In some embodiments, the intumescent material 110 and/or intumescent material layer 110 is contact with the refractory material 120 and/or refractory material layer 120. Typically, in such an embodiment, the refractory material and/or refractory material layer 120 is positioned between the substrate 130 and the intumescent material 110 and/or intumescent material layer 110.

In some embodiments, the intumescent material 110 and/or intumescent material layer 110 is in contact with one of the first and second surfaces of the substrate and the refractory material 120 and/or refractory material layer 120 is in contact with the other of the first and second surfaces of the substrate 130. In other words, the intumescent material 110 and/or intumescent material layer 110 and the refractory material 120 and/or refractory material layer 120 are, respectively, in contact with opposing surfaces of the substrate.

Some embodiments can include step 350. Step 350 can include a degassing of one or more of the applied intumescent material 110 and/or intumescent material layer 110 and the refractory material 120 and/or refractory material layer 120. Step 350 can be carried out after one or more of step 310 and 320.

Some embodiments can include step 360. Step 370 can include drying of one or more of the materials applied any one of steps 310 and 320. The drying can be conducted a temperature of at about ambient temperature or to a temperature above ambient. Typically, the drying temperature can be from about 5 to about 250 degrees Celsius, more typically from about 10 to about 50 Celsius, or more typically from about 15 to about 45 degrees Celsius. The drying period can be more than about 10 seconds and less than about week. Generally, the drying time is no more than about 24 hours, more generally no more than about 18 hours, even more no more generally than about 8 hours, yet even more generally no more than about 4 hours, still yet even more generally no more than about 2 hours, and yet still no more than about 1 hour. Step 360 can be carried out after one or more of steps 310, 320 and 350.

Some embodiments can include step 370. Step 370 can include curing of one or more of the materials applied any one of steps 310 and 320. Furthermore, step 370 can include curing of one or more of the materials dried applied step 370. The curing can be conducted a temperature of at about ambient temperature or to a temperature above ambient. Typically, the drying temperature can be from about 5 to about 550 degrees, more typically from about 10 to about 50 Celsius, more typically from about 20 to about 450 degrees Celsius, or even more typically from about 100 to about 375 degrees Celsius. The curing period can be more than about 10 minutes and less than about 8 hours. Generally, the curing time is no more than about 6 hours, more generally no more than about 5 hours, even more no more generally than about 4 hours, yet even more generally no more than about 3 hours, still yet even more generally no more than about 2 hours, and yet still no more than about 1 hour. Step 370 can be carried out after one or more of steps 310, 320, 350 and 360.

In some embodiments, one or more of steps 350, 360 and 370 can conducted sequentially. In some embodiments, steps 350 and 360 are combined into a single step. In some embodiments, steps 350 and 360 are combined into a single step and conducted before step 370. In some embodiments, steps 350, 360 and 370 are be combined into a single step. In some embodiments, steps 360 and 370 are combined into a single step that is conducted after step 350.

In some embodiments, one or more of steps 350, 360 and 370 are conducted between steps 310 and 320.

In some embodiments, one or more of steps 350, 360 and 370 are conducted after each of steps 310 and 320.

### EXAMPLES

### Electrochemical Cell Failure Testing

In an experimental test (of failure and thermal runaway) of a thermal isolation material with thermocouples on opposing sides of the thermal isolation material, flame impingement on one side, and an infrared camera measuring the temperature of the side opposite the flame impingement. Moreover, to ensure another layer of data accuracy, a thermocouple was utilized to ensure that the temperature of hot-plate is close to the temperature reading obtained from the infrared camera. The test configuration was designed to simulate a catastrophic cell failure, leading to open flame exposure. The temperature was measured on the opposite side of the thermal isolation material 100 (with respect to the flame exposure side) with a set point located for normalizing emissivity consideration. The thermal isolation material 100 showed substantial heat shielding capability with a temperature rise of only about 170 degrees Celsius after an exposure time of about 15 seconds, to a propane flame having a temperature of about 1,980 degrees Celsius.

In another experiment, designed to simulate failure of an electrochemical cell exposure to an open flame from a deflagration event. The test was designed to have the open flame touch the intumescent material layer 110 of the thermal isolation material 100 wrapping a lithium ion electrochemical cell. In this experiment, the intumescent material layer 110 had a thickness of about 0.03 inches, the open flame temperature impinging the intumescent material layer 110 was about 1,980 degrees Celsius. The flame source is adjacent to a LiFePO₄ electrochemical cell undergoing deflagration and thermal runaway. The impinging flam charred the intumescent material layer 110, and raised the internal temperature of the lithium ion battery to no more than about 230 degrees Celsius. As such, the electrochemical lithium ion battery did not experience one or more of deflagration and thermal runaway.

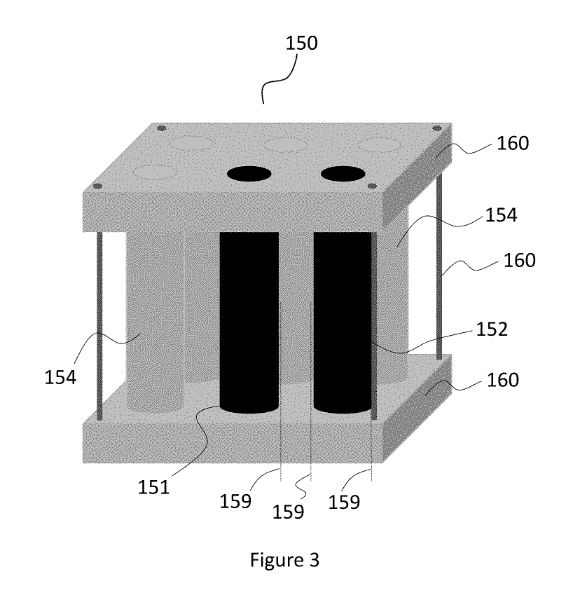

A method of inducing cell failure by heating a single cell 151 in a module 150 that contained two electrochemical cells 152 and four dummy cells (electrochemically inactive) 154 mounted in a holder 160 was developed. The dummy cells were used to limit the number of electrochemical cells used during this phase of testing. The dummy cells also mimic the thermal flow characteristics of the module 150. The two electrochemical cells and four dummy cells were arranged and perpendicular array geometry (See FIG. 3). The spacing between the cells in the module was about 0.03 inches.

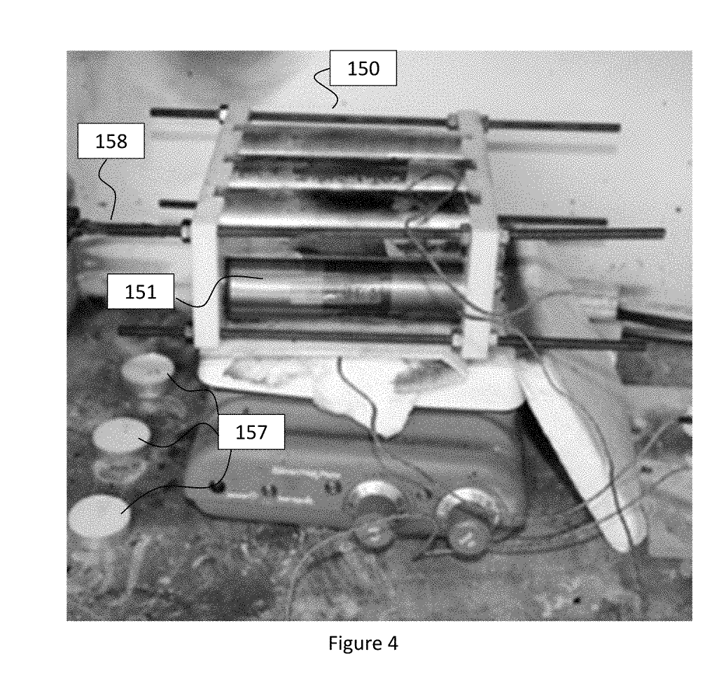

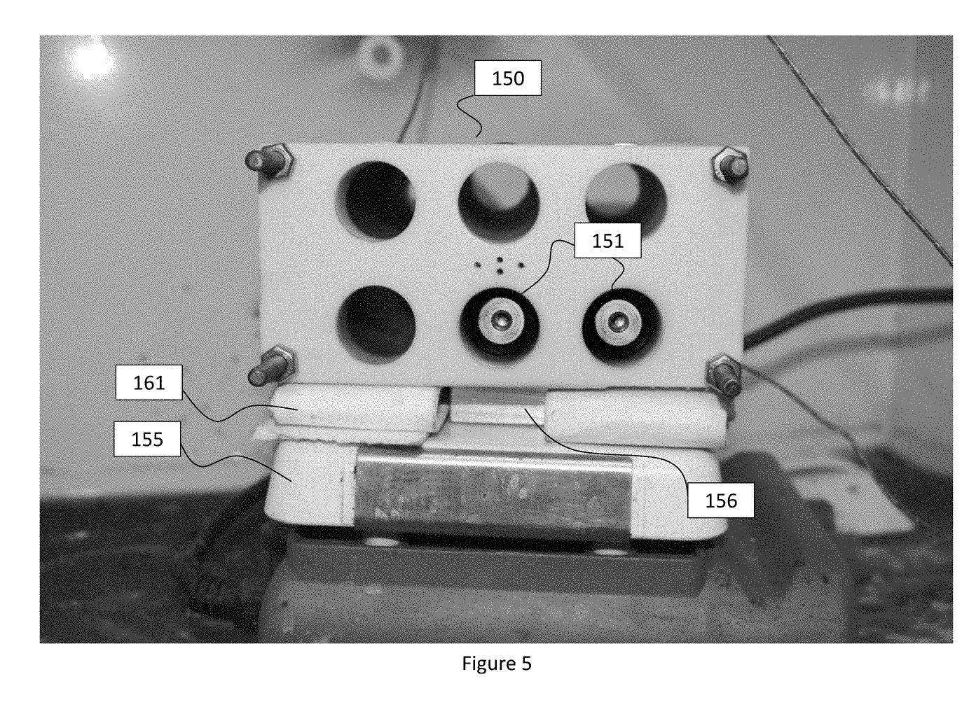

The entire module 150 was positioned on a hot plate 155 with a heater connector 156 that served to conduct heat to the single cell 151 in the module 150 (FIGS. 4 and 5). A refractory insulation 161 was placed around the sides of the holders to reduce radiative and convective heating of the electrochemical cells 152 and dummy cells 154 in the module 150. Candles 157 and a hot surface furnace igniter 158 are also depicted. The candles 157 and hot surface furnace igniter 158 serve to ignite any electrolyte vapor vented during heating. The candles 157 and hot surface furnace igniter 158 were generally positioned about 1 to 2 inches from the vent of heated single cell 151.

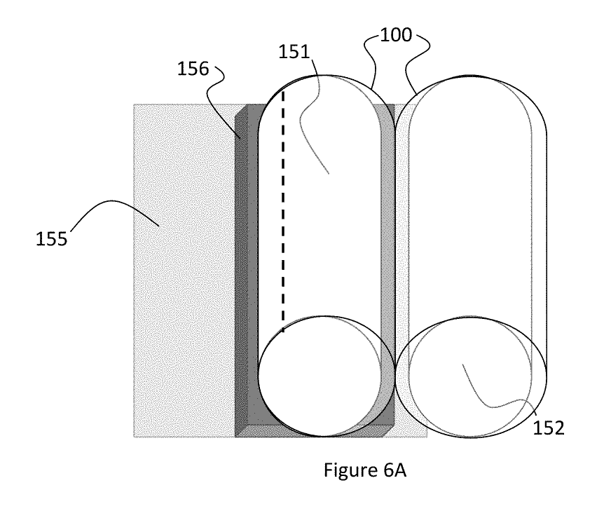

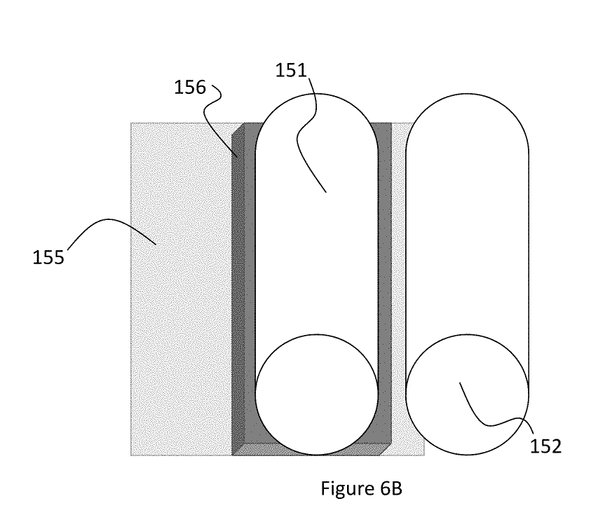

Thermocouples 159 were placed on the heater connector 156, the surface of the heated single cell 151, and the near and far surfaces of the adjacent cells of the electrochemical cells 152, and the dummy cells 154. When a thermal isolation material 100 is used, the thermocouples positioned underneath the thermal isolation material 100 at the same positions on the cells. The thermal isolation material 100 can be wrapped fully around the adjacent electrochemical cells 152 and the dummy cells 154, and halfway around the heated single cell 151 with an exposed area where the holder 160 contacts the heated single cell 151 to ensure identical heating with and without a thermal isolation material 100. A diagram of the thermocouple placement is depicted in FIGS. 4, 5 and 6A and 6B.

The electrochemical cell 152 was slightly overcharged before initiating testing to an approximate 115% state of charge to increase the possibility of thermal runaway and to induce ignition and thermal runaway. A charging program was developed to charge the electrochemical cell 152 without deploying the current interrupt device within the electrochemical cell 152.

To ensure that the energy from the heated single cell 151 is largely responsible for any heating of the adjacent cells electrochemical cell 152 and dummy cells 154, the hot plate 155 is turned off after heated single cell 151 venting.

Module Failure Results, without a Thermal Isolation Material

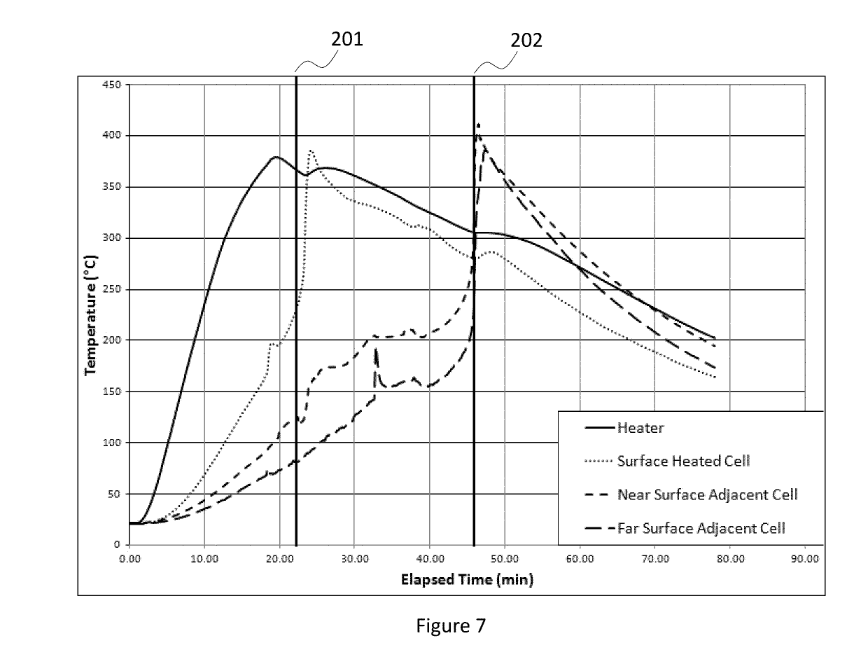

Module 150 failure tests were performed using the above method with and without the thermal isolation material 100 (FIG. 7). During a baseline experiment without the thermal isolation material 100, forceful venting occurred, followed by thermal runaway of the heated single cell 151. The time between venting and thermal runaway was about 4.5 minutes. The thermal runaway from the heated single cell 151 venting emitted from about one to three foot flames and the thermal runaway of the adjacent electrochemical cell 152 displayed from about one to three foot or more flames. Moreover, the thermal runaway flames are expressed with such force that a safety door utilized to contain the flames was disengaged from its magnetic security device and blown open by the force of the heated single cell 151 venting. Venting of the adjacent electrochemical cell 152 typically occurred about 5 to about 15 minutes after thermal runaway of the heated single cell 151. The force of the adjacent electrochemical cell 152 venting was enough to disengage the security door from its magnetic security device and blown open by the force to break a nylon retention device holding the security door in place, allowing the security door to swing open. Thermal runaway of the adjacent electrochemical cell 152 occurred from about 10 to about 20 minutes after venting of the adjacent electrochemical cell 152.

Heated single cell 151 and adjacent electrochemical cell 152 thermal runaway temperatures are denoted by the dotted lines 201 (heated single cell) and 202 (adjacent electrochemical cell 152. The temperature spikes are nearly identical for the heated single cell 151 and adjacent electrochemical cell 152 thermal runaway events, with peak temperatures of about 400 degrees Celsius, which demonstrates the consistency of these thermal runaway events. Unlike previous tests, a large spike in the adjacent electrochemical cell 152 surface temperature was not observed during the thermal runaway of the heated single cell 151. While not wanting to be limited by theory, it is believed that the lack of large thermal spike in the adjacent electrochemical cell 152 could be due to wind providing convective cooling to the cells during the test. However, spikes in the adjacent electrochemical cell 152 near and far surface temperatures were observed after the thermal runaway of the heated single cell 151, possibly indicating that without the thermal isolation material 100 the adjacent electrochemical cell 152 experience surges of heat from the burning adjacent electrochemical cell 152.

At the conclusion of the thermal testing the holder 160 near the adjacent electrochemical cell 152 vents is almost completely melted. The melting of the holder 160 allows the single cell 151, the electrochemical cell 152, and the four dummy cells 154 to shift and come into contact. After thermal runaway, the electrochemical cell 152 were very charred and the voltage of the charred electrochemical cell 152 was zero volts. The zero voltage confirms that the electrochemical cell 152 had undergone a thermal runaway.

Module Failure Results, with a Thermal Isolation Material

A test substantially similar to the above module failure test without a thermal isolation material 100 was performed with adjacent electrochemical cell(s) 152 wrapped with the thermal isolation material 100. Similar to the previous experiment, the initial venting and ignition of the heated single cell 151 was forceful enough to blow the enclosure door open.

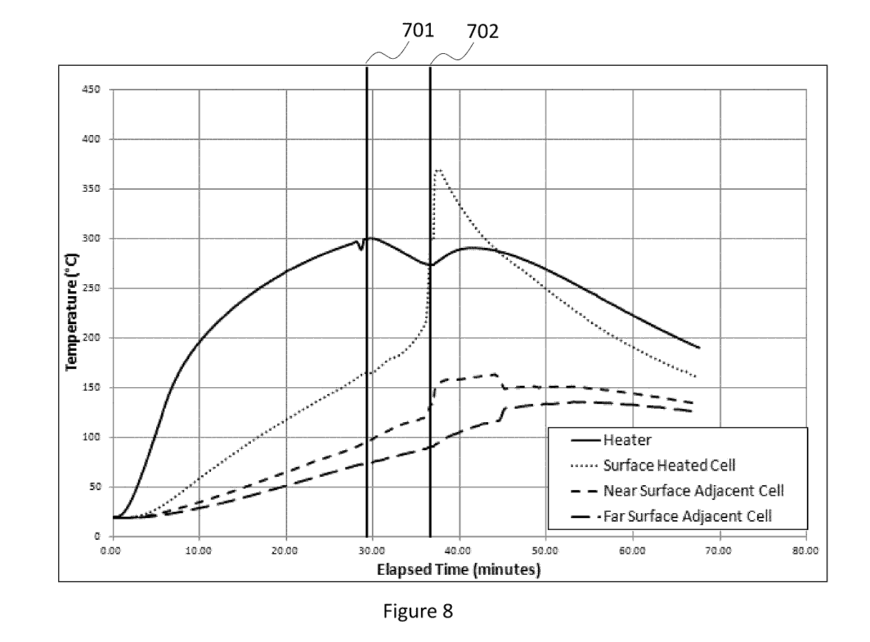

The venting and thermal runaway was comparable in the experiments with and without the thermal isolation material 100. However, in the experiment with the adjacent electrochemical cell(s) wrapped with the thermal isolation material 100 did not explode. FIG. 8 depicts the temperature data from the experiment utilizing the thermal isolation material 100. Line 701 depicts the time of the heated cell venting and explosion, and line 702 depicts the time of the heated cell runaway. Thermocouples were located in the same places as the above experiment without the thermal isolation material 100. However, the thermocouples were located under the respective thermal isolation material 100 wrapping for one or more of the single heated cell 151, the electrochemical cell 152 and the dummy cells. It can be seen that with thermal isolation material 100 wrapping of the cells there were no spikes or surges in cell temperatures. The lack of temperature spikes or surges indicates that thermal isolation material 100 can effectively shield electrochemical cell 152 from thermal shock caused by electrochemical cell 152 thermal runaway. While not wanting to be limited by theory, the thermal isolation material 100 can accomplish this by one or more of heat reflection from the refractory layer 120, thermal conduction axially from the substrate 130, and heat absorption from one or more of the intumescent layer 110 and phase change material 140.

The damage to the module 150 after the test was assessed. The holder 160 had significant charring and melting. The heated single cell 151, the surrounding dummy cells 154 and adjacent electrochemical cell 152 were also damaged. Cell voltages were determined. That voltage of the heated single cell 151 was zero, consistent with a thermal runaway event. However, the adjacent electrochemical cell 152 remained fully charged, indicating that cascading failure was not induced.

The heated single cell 151 and adjacent electrochemical cell 152 were significantly charred and deployed and burned all the intumescent material 110. However, the thermal isolation material 100 remained intact and structurally sound, and the refractory material 120 maintained good adhesion.

The adjacent electrochemical cell 152 had minimal melting of the shrink-wrap and little damage otherwise, indicating the efficacy of the thermal isolation material 100 in mitigating thermal runaway. The thermal isolation material 100 had some charring and the intumescent material 110 changed color, indicating that a phase change has occurred. The thermal isolation material 100 remained intact and with very little damage.

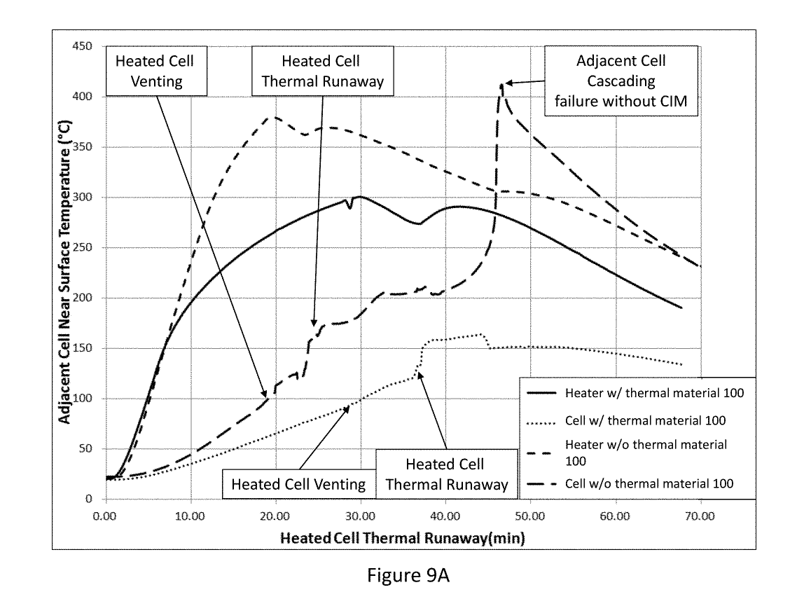

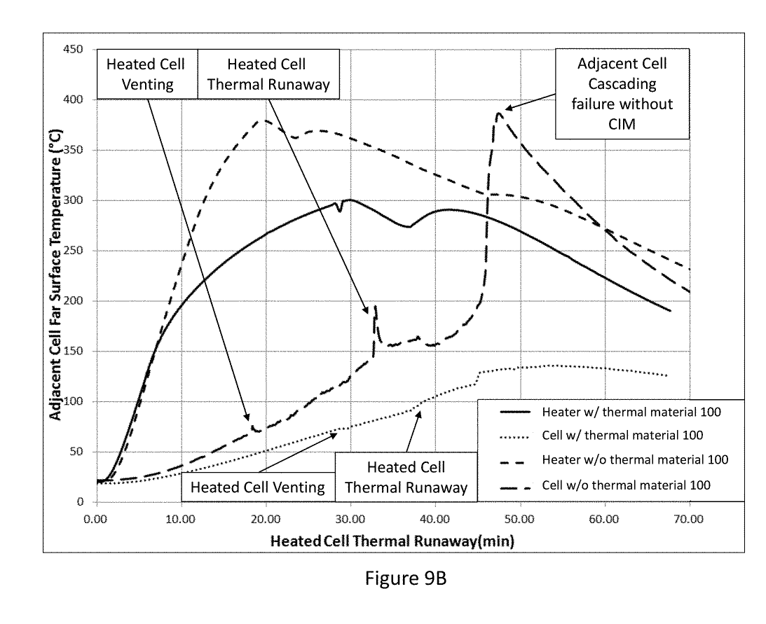

FIG. 9A depicts, the temperature rise experienced by surfaces of the adjacent electrochemical cell 152 during thermal runaway of the heated single cell 151 with and without the thermal isolation material. A sharp rise in temperature of the adjacent electrochemical cell 152 without the thermal isolation material 100 indicates a thermal runaway. About a 350 degrees Celsius insulation can be obtained with the thermal isolation material 100 (FIG. 9B). The thermal isolation material 100 can significantly mitigate a thermal runaway event in one or more adjacent cells.

Furthermore, the thermal isolation material 100 can extend the time between heated primary cell 151 venting and thermal runaway of one or more adjacent cells, such as but not limited to adjacent electrochemical cell 152. While not wanting to be limited by theory, it is believed that the thermal isolation material 100 one or more inhibits or decreases direct flame contact to the body of the heated primary cell 151 after it has one or more vented and ignited. The thermal isolation material 100 is believed to deflect some of the flame. The deflection of the flame can decrease the rate of heating. Slower thermal runaway response can be attributed to the decreased rate of heating. The slower thermal run away can also be achieved for vented and ignited cells.

Furthermore, the thermal isolation material 100 can protect an adjacent cell from rapid temperature increases. The decrease in rate of temperature increase can reduce the overall heating rate. Moreover, when the thermal isolation material 100 is lacking the number of temperature spikes observed in adjacent cells increases, compared to when a thermal isolation material is present. While not wanting to be limited by theory, it is believed that the temperature spikes are due to flames directly impinging on the adjacent cell surface. With the thermal isolation material 100, the adjacent cell exhibits a smoother temperature profile as indicating by the fewer number of temperature spikes. The lack of damage and the prevention of cascading failure of the electrochemical cells show the advantages of the thermal isolation material 100.

### Mechanical Testing

The mechanical strength of the thermal isolation material 100 to withstand pressurized gas impingement was determined. The test involves holding the thermal isolation material 100 between two metal flanges when exposing it to compressed nitrogen gas. The metal flanges have a 2″ exposed diameter. The compressed nitrogen gas was delivered through a steel tube having an outer diameter of about 0.25 inches and inner diameter of about 0.12 inch steel tube mounted about 0.5 inch from the thermal isolation material 100 surface. Tests were performed at about 100 psig for about 3 minutes and at 300 psig for about 1 minute.

The test was performed on thermal isolation material 100 samples using an orientation in which the nozzle directed pressurized nitrogen at 100 psig for 3 minutes at the intumescent material 110 side of the thermal isolation material 100. The intumescent material 110 remained intact with no damage. Similar testing of the refractory material 120 showed no damage. One sample did show some shown some minor flake delamination. Tests performed at a 300 psig pressure for 1 minute pressure test show the intumescent material layer 110 remains un-damaged and the refractory material layer 120 experienced a very small amount of delamination. The thermal isolation material 100 experienced no penetration by the pressurized nitrogen impingement.

A burn through test was performed to determine the extent of delamination of the refractory material layer 120 after pressurized gas impingement on the thermal isolation material 100. The flame resistance of the thermal isolation material 100 after the pressurized gas impingement was also determined by burn through test. During this test a propane torch was positioned about 0.5 inches from the surface of the thermal isolation mater 100 and allowed to burn on full setting for 10 minutes. The temperature of the flame was about 1,200 degrees Celsius.

The propane flame was directed at the intumescent side 110 of the thermal isolation material 100. The propane flame activated and, then, burned the intumescent material layer 110. The refractory material layer 120 remained largely un-damaged. However, after exposure to the flame, very small cracks in the substrate foil 130. While not wanting to be limited by theory, it is believed that impingement of the flame on the intumescent material layer 110 side of the thermal isolation material 100 provided little to no flame resistance, allowing the substrate 130 to be more easily damaged.

For some thermal isolation materials, a flame impinging the refractory material 120 can activate the intumescent material 110. The activation can produce a high expansion of the intumescent material 110. For example, the expansion can increase the thickness of the intumescent material layer 110 of 1 inch or more. Moreover, the expanded intumescent material layer 110 can burn off over the course of the test. However, the burn testing penetration of the thermal isolation material 100 was not observed. While not wanting to be limited by theory, it is believed that the refractory layer 120 provides flame resistance. Moreover, wrapping of the thermal isolation material 100 around the electrochemical cell with the refractory material layer 120 facing outwards provides flame resistance. It is further believed that wrapping the thermal isolation material 100 with the refractory layer 120 facing outwards substantially prevents, or at least substantially inhibits, an impinging flame from t penetrating an adjacent cell.

### Mounting the Thermal Isolation Material:

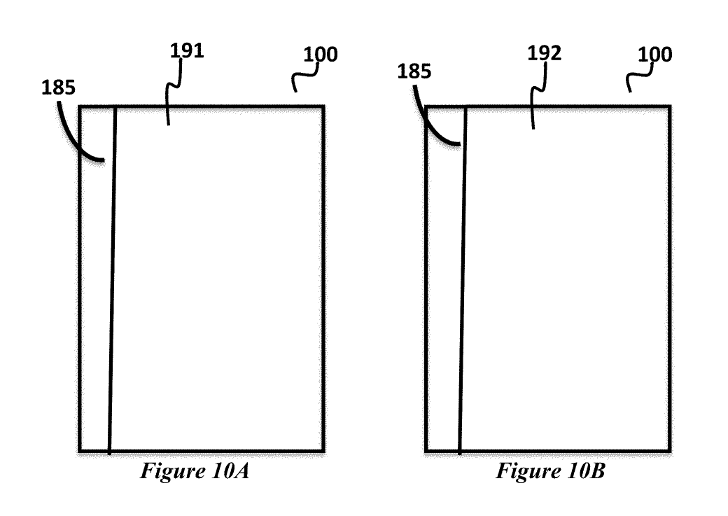

The mounting of the thermal isolation material 100 includes one or more of a cut process and an etch process (FIGS. 10A and 10B). The thermal isolation material 100 is cut to the size of electrochemical cell. Generally, after cutting of the thermal isolation material 100, a tab 185 is laser etched on each side of the thermal isolation material 100 to provide a clean surface for epoxy bonding. After the one or more the cut and etch processes, the thermal isolation material 100 is wrapped around an electrochemical cell and tab edges 185 of the thermal isolation material 100 are sealed with a high temperature epoxy (FIGS. 10A and 10B). The high temperature epoxy can be applied to one or more of the tab 185 edges. After applying the epoxy to the one or more of the tab 185 edges, the thermal isolation material 100 is usually be wrapped around an electrochemical cell. A circumferential pressure is applied to hold the thermal isolation material 100 in place about the electrochemical cell as the epoxy cures. Non-limiting examples of suitable devices for applying a circumferential pressure are sip ties, hose clamps, and such. The etched tabs are located such that substantially the entire circumference of the electrochemical cell is protected by the intumescent material 110 and refractory material 120 of the thermal isolation material 100. The thermal isolation material 100 is wrapped substantially about an electrochemical cell such that one or more of the substrate 130 and the electrochemical cell are not exposed. Stated another way, the thermal isolation material 100 is wrapped substantially about an electrochemical cell such that circumference of the electrochemical cell is fully wrapped by one or more of the intumescent material 110 and refractory material 120 layers of the thermal isolation material 100. The devices applying the circumferential pressure are removed the electrochemical cell prior to placing the electrochemical cell in use. Having one or more of the thermal isolation material 100 wrapped substantially about an electrochemical cell such that circumference of the electrochemical cell is fully wrapped by one or more of the intumescent material 110 and refractory material 120 layers of the thermal isolation material 100 and the epoxy sufficiently cured substantially reduces delamination of thermal isolation material 100 after one or more of flame impingement and thermal runaway.

Generally, the epoxy has a maximum temperature of one of 150 degrees Celsius or more, more generally of about 180 degrees Celsius or more, even more generally of about 200 degrees Celsius or more, yet even more generally of about 225 degrees Celsius or more, still yet of about 235 degrees Celsius or more, still yet of about 245 degrees Celsius or more, or yet of about 255 degrees Celsius or more. The high temperature epoxy can give one or more of durable and stable seal under thermal runaway conditions. According to some embodiments the epoxy is commonly cured for one of more than about 1 hour, even more commonly for more than about 2 hours, even more commonly more than about 3 hours, yet even more commonly more than about 4 hours, still yet even more commonly more than about 5 hours, still yet even more commonly more than about 6 hours, still yet even more commonly more than about 7 hours, still yet even more commonly more than about 8 hours, still yet even more commonly more than about 9 hours, still yet even more commonly more than about 10 hours, still yet even more commonly more than about 12 hours, still yet even more commonly more than about 14 hours, still yet even more commonly more than about 16 hours, still yet even more commonly more than about 18 hours, still yet even more commonly more than about 20 hours, still yet even more commonly more than about 22 hours, or yet still even more commonly more than about 24 hours. Sufficient curing of epoxy bonding substantially improves one or more of the mounting and bonding of the thermal isolation material 100 on the electrochemical cell under one or more of the high temperature and pressure conditions. A non-limiting example of a suitable high temperature epoxy is DURALCO™ 4538N.

In some embodiments, the thermal isolation material 100 can be mounted by soldering. The soldering method is similar to the epoxy mounting method where the solder replaces the epoxy. That is, the edges of the thermal isolation material are etched prior to soldering. More specifically, the solder is spread on the inner and outer etched tabs using a heat spreading material such a flux, and then the tabs are bonded together using an heat spreading material and the heat of a soldering iron.

In some embodiments, the thermal isolation material 100 can be mounted by laser welding. After wrapping the thermal isolation material 100 around the electrochemical cell, the tab ends would be welding together using a high-powered laser at the overlapping etched tab ends.

### Failure Tests of the Mounted Thermal Isolation Material

The failure tests were conducted as described above in the electrochemical cell failure testing examples. The two electrochemical cells were two live 12 Ah 38-140 LiFePO₄ cells were used along with four aluminum cylinder dummy cells. The two electrochemical cells were overcharged to about 115% state of charge. A metal connector was used to conduct heat to a single cell in the module and a refractory insulation was used to prevent heat transfer to the electrochemical cells and/dummy cells in the module. The heat source was turned off directly after the heated cell vented to limit the amount of energy being imparted into the module from the heater

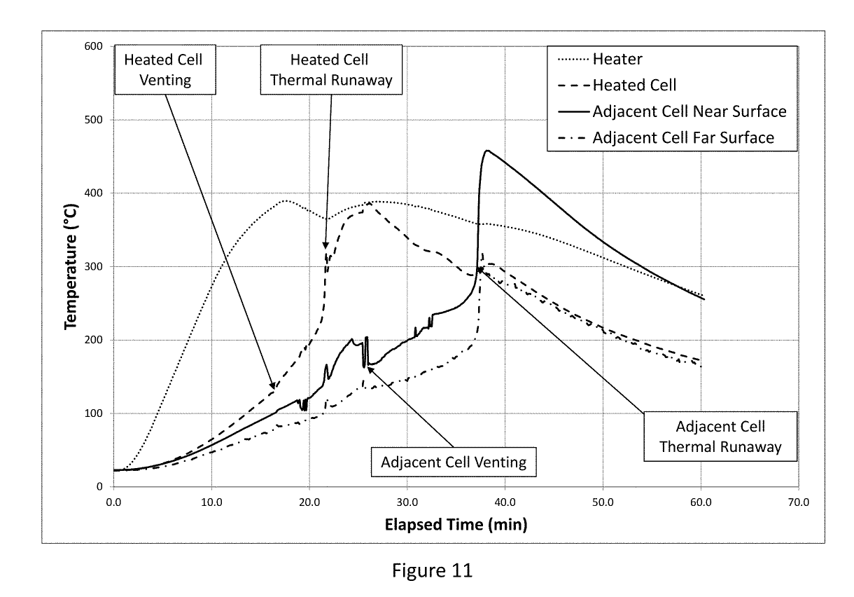

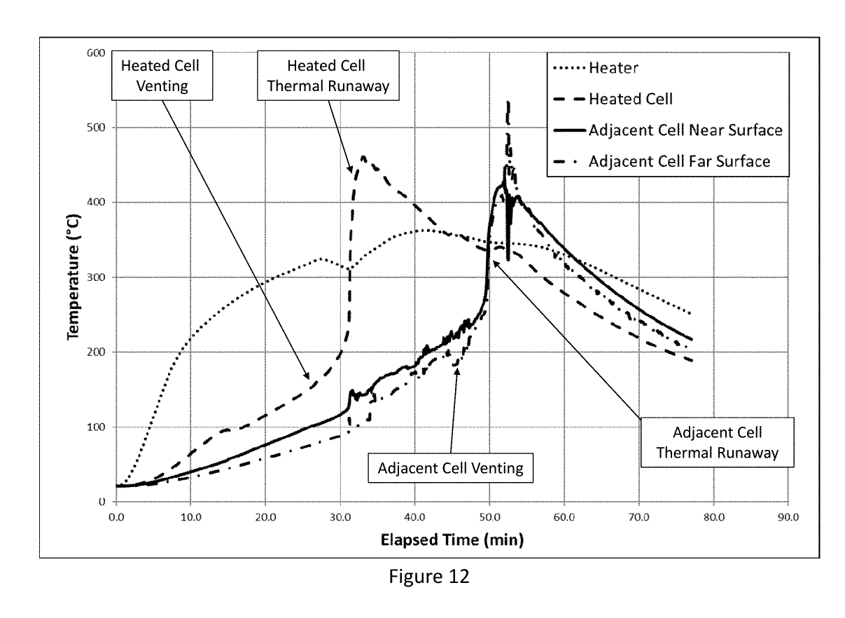

FIGS. 11 and 12 depict cascading failure for modules with and without the thermal isolation material 100. The temperature data from the module failure test without the thermal isolation material 100 is depicted in FIG. 11. The cascading failure of the adjacent cell occurred quickly, about 4 minutes after the heated cell thermal runaway. Contrasted to module without the thermal isolation material 100 (FIGS. 7, 9A and 9B), the module with the thermal isolation material (FIG. 12) shows a significantly increased delay in cascading failure. The cascading failure times for the modules with and without the thermal isolation material 100 are shown Table 2 for the cascading failure times with and without the thermal isolation material 100. The cascading failure time of heated cell venting to adjacent cell venting, and heated cell thermal runaway to adjacent cell venting are significantly increase when the thermal isolation material 100 is present. The thermal isolation material 100 can double the delay in the cascading venting events. Furthermore, the thermal isolation material 100 can increase the delay between the heated thermal runaway and adjacent venting.

TABLE 2

| | Module Failure | Module Failure |
|---|---|---|
| | without Thermal | with Thermal |
| | Isolation Material | Isolation Material |
| Heated Venting to | 8.8 | 19.0 |
| Adjacent Venting | | |
| Heated TR to | 4.0 | 14.0 |
| Adjacent Venting | | |

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A composition comprising:
an intumescent material;
a refractory material; and
a substrate positioned between adhered to each of the intumescent material and the refractory material.

2. The composition of claim 1, wherein each of the intumescent material and the refractory material are layers.

3. The composition of claim 1, wherein each of the intumescent material and the refractory material are one or more of flexible and bendable around a radii of curvature of 10 mm or more diameter.

4. The composition of claim 1, wherein the substrate is a metallic folio having a thickness of no more than about 1,600 micrometers.

5. The composition of claim 2, wherein the intumescent material layer has a thickness of no more than about 800 micrometers.

6. The composition of claim 2, wherein the refractory material layer has a thickness of no more than about 800 micrometers.

7. The composition of claim 1, where the refractory material comprises a binder.

8. A composition comprising:
a substrate;
a refractory material layer; and
an intumescent material layer, wherein the substrate is positioned between and adhered to the intumescent material layer and the refractory material layer and wherein the substrate, the intumescent material and the refractory material are one or more of flexible and bendable around a radii of curvature of 10 mm or more diameter.

9. The composition of claim 8, wherein the substrate is a metallic folio having a thickness of no more than about 1,600 micrometers.

10. The composition of claim 8, wherein the intumescent material layer has a thickness of no more than about 800 micrometers.

11. The composition of claim 8, wherein the refractory material layer has a thickness of no more than about 800 micrometers.

12. The composition of claim 8, where the refractory material comprises a binder.

13. A method, comprising:
providing a substrate having opposing first and second sides;
applying an intumescent material to the substrate; and
applying a refractory material to the substrate to form a thermal isolation material, wherein the one following is true:
(i) wherein the intumescent material is applied on the first side and wherein the refractory material is applied on the second side;
(ii) wherein the intumescent material is positioned between the substrate and the refractory material; and
(ii) wherein the refractory material is positioned between the substrate and the intumescent material.

14. The method of claim 13, further comprising:
modifying one or more of the first and second sides, wherein the modification of the one or more first and second sides comprises one or more of introducing surface variations and forming surface reactive groups.

15. The method of claim 13, wherein the step of applying the intumescent material to the substrate comprises contacting the intumescent layer with one of first and second surfaces of the substrate and wherein the step of applying the refractory material comprised contacting the refractory material with the other of first and second surfaces of the substrate.

16. The method of claim 13, wherein the step of applying the intumescent material to the substrate comprises applying the intumescent material with one or more of a kiss-roller, curtain coater, matte applicator, a draw down bar, a spray coater, a screen coater, a calendar coater, and a pad coater and wherein the step of applying the refractory material to the substrate comprises applying the refractory material with one or more of a kiss-roller, curtain coater, matte applicator, a draw down bar, a spray coater, a screen coater, a calendar coater, and a pad coater.

17. The method of claim 13, further comprising:
degassing one or more the intumescent material and the refractory material after the applying of the one or more intumescent and refractory materials.

18. The method of claim 13, further comprising:
drying one or more the intumescent material and the refractory material after the applying of the one or more intumescent and refractory materials.

19. The method of claim 13, further comprising:
curing one or more the intumescent material and the refractory material after the applying of the one or more intumescent and refractory materials.

20. The method of claim 13, wherein (i) is true and
further comprising:
providing an electrochemical cell;
mounting the thermal isolation material on the electrochemical, wherein the refractory material is positioned nearer to and adjacent to the electrochemical cell and wherein the intumescent material faces outward and is further away from electrochemical cell than the refractory material.
